(19) United States
(12) Patent Application Publication
(10) Pub. No.: US 2026/0298445 A1
(43) Pub. Date: Oct. 1, 2026

(54) ACCESS COVER ASSEMBLIES FOR LUMINAIRES

(71) Applicant: SIGNIFY HOLDING B.V., EINDHOVEN (NL)

(72) Inventor: TIMOTHY GLENN WRIGHT, PEACHTREE CITY, GA (US)

(21) Appl. No.: 19/163,416

(22) PCT Filed: Feb. 27, 2024
(86) PCT No.: PCT/EP2024/054873

§ 371 Date: Sep. 9, 2025

Related U.S. Application Data
(60) Provisional application No. 63/451,693, filed on Mar. 13, 2023.

(30) Foreign Application Priority Data
Mar. 24, 2023 (EP) 23164086.3

(51) Int. Cl. F21V 15/01; F21S 8/06; F21V 23/00

(52) U.S. Cl. CPC F21V 15/01; F21S 8/06; F21V 23/007

(57) ABSTRACT

A luminaire can include an access cover assembly. The access cover assembly can include a transition component and an access cover that includes a body; a bottom collar that includes a transition component coupling feature configured to couple to an access cover coupling feature of the transition component, where the bottom collar is configured to cover the top end of a bottom luminaire portion when the access cover is in a fully closed position; and a top collar configured to abut against and cover a bottom end of a top luminaire portion when the access cover is in the fully closed position. The access cover assembly can also include a support component disposed within a space between the transition component and the top luminaire portion, wherein the support component is configured to be exposed to an ambient environment when the access cover is moved to a fully open position.

### TECHNICAL FIELD

The present disclosure relates generally to lighting systems, and more particularly to systems, methods, and devices for access cover assemblies for luminaires.

### BACKGROUND

At times, luminaires have internal components that fail, start to fail, or no longer perform the function required by a user. In such cases, because the luminaire housing is not designed to provide easy access to such components, the luminaire may need to be completely replaced. Alternatively, the luminaire must be uninstalled/removed and taken apart to access the component to be repaired/replaced. The component is then removed and either repaired or replaced. Then the luminaire must be reassembled and reinstalled. These efforts take time and can end up incurring costs and expenses that outweigh what would otherwise be a simple change.

### SUMMARY

In general, in one aspect, the disclosure relates to an access cover assembly for a luminaire. The access cover assembly can include a transition component having an access cover coupling feature and a bottom luminaire portion coupling feature. The access cover assembly can also include an access cover having a body, a bottom collar, and a top collar. The body of the access cover can include a wall, where the wall forms a cavity with an open top and an open bottom. The bottom collar of the access cover can be located along a bottom of the body, where the bottom collar includes a transition component coupling feature configured to couple to the access cover coupling feature of the transition component, and where the bottom collar is configured to cover a top end of a bottom luminaire portion when the access cover coupling feature and the transition component coupling feature are coupled to each other. The top collar of the access cover can be located along a top of the body, where the top collar is configured to abut against and cover a bottom end of a top luminaire portion when the access cover coupling feature and the transition component coupling feature are coupled to each other. The access cover assembly can also include a support component disposed within a space between the transition component and the top luminaire portion, where the support component is disposed within the cavity formed by the wall of the body when the access cover coupling feature and the transition component coupling feature are coupled to each other, and where the support component is configured to be exposed to an ambient environment when the access cover coupling feature and the transition component coupling feature are decoupled from each other and when the access cover is moved toward the top luminaire portion and away from the transition component.

In other aspects, the disclosure relates to a luminaire that includes a top luminaire portion. The luminaire can also include a bottom luminaire portion having a transition component coupling feature positioned toward a top end. The luminaire can further include an access cover assembly, which can include a transition component having an access cover coupling feature and a bottom luminaire portion coupling feature. The access cover assembly can also include an access cover having a body, a top collar, and a bottom collar. The body of the access cover can include a wall, where the wall forms a cavity with an open top and an open bottom. The bottom collar of the access cover can be located along a bottom of the body, where the bottom collar includes a transition component coupling feature configured to couple to the access cover coupling feature of the transition component, and where the bottom collar is configured to cover the top end of the bottom luminaire portion when the access cover is in a fully closed position relative to the transition component. The top collar of the access cover can be located along a top of the body, where the top collar is configured to abut against and cover a bottom end of the top luminaire portion when the access cover is in the fully closed position. The access cover assembly of the luminaire can also include a support component disposed within a space between the transition component and the top luminaire portion, where the support component is disposed within the cavity formed by the wall of the body when the access cover is in the fully closed position, and where the support component is configured to be exposed to an ambient environment when the access cover coupling feature and the transition component coupling feature are decoupled from each other and when the access cover is moved to a fully open position.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIGS. 1A and 1B show a system block diagram of a lighting system that includes a luminaire with an access cover assembly according to certain example embodiments.

FIGS. 2A through 2E show various views of a luminaire with an access cover assembly according to certain example embodiments.

FIGS. 3A through 3D show various views of the access cover of the luminaire of FIGS. 2A through 2E according to certain example embodiments.

FIGS. 4A through 4D show various views of the top luminaire portion of the luminaire of FIGS. 2A through 2E according to certain example embodiments.

FIGS. 5A through 5D show various views of the transition component of the luminaire of FIGS. 2A through 2E according to certain example embodiments.

FIGS. 6A and 6B show various views of a support component of the luminaire of FIGS. 2A through 2E according to certain example embodiments.

FIG. 7 shows another luminaire with the access cover in a closed position according to certain example embodiments.

FIGS. 8A and 8B show the luminaire of FIG. 7 with the access cover in an open position according to certain example embodiments.

FIG. 9 shows a system block diagram of a luminaire with another access cover assembly according to certain example embodiments.

FIG. 10 shows a system block diagram of a luminaire with yet another access cover assembly according to certain example embodiments.

FIG. 11 shows a system block diagram of the luminaire of FIG. 10 with part of the access cover in a changed position relative to what is shown in FIG. 10 according to certain example embodiments.

FIG. 12 shows a system block diagram of the luminaire of FIG. 10 with another part of the access cover in a changed position relative to what is shown in FIGS. 10 and 11 according to certain example embodiments.

### DETAILED DESCRIPTION

In general, example embodiments provide systems, methods, and devices for access cover assemblies for luminaires. Example embodiments can provide a number of benefits. Such benefits can include, but are not limited to, more controlled light an aesthetically pleasing appearance, ease of access for replacement and/or maintenance of various components (e.g., sensor devices, dimmers, surge protectors) of the luminaire, and compliance with industry standards that apply to luminaires located in certain environments. Example embodiments can be used with new luminaires or retrofit with existing luminaires. Example embodiments described herein can be used with any of a number of different types of luminaires, including but not limited to pendant fixtures, hanging fixtures, and other fixtures where the body of the fixture is exposed to the ambient environment.

Luminaires with example access cover assemblies can be located in one or more of any of a number of environments. Examples of such environments can include, but are not limited to, indoors, outdoors, a parking garage, a parking lot, a manufacturing plant, a warehouse, a kitchen, and a storage facility, any of which can be climate-controlled or non-climate-controlled.

Luminaires with example access cover assemblies can be directly or indirectly mounted onto any of a number of different structures. Such structures can include, but are not limited to, a pole, a building wall, an outdoor facade, concrete, and a beam. A user may be any person that interacts with luminaires. Examples of a user may include, but are not limited to, an engineer, an electrician, an instrumentation and controls technician, a mechanic, an operator, a property manager, a homeowner, a tenant, an employee, a consultant, a contractor, and a manufacturer's representative. As used herein, a luminaire is a general term that can include a light fixture, a lighting device, an illumination fixture, and similar devices.

Luminaires with example access cover assemblies (including portions thereof) can be made of one or more of a number of suitable materials to allow the luminaires to meet certain standards and/or regulations while also maintaining durability in light of the one or more conditions under which the luminaires and/or other associated components of the luminaires can be exposed. Examples of such materials can include, but are not limited to, aluminum, stainless steel, fiberglass, glass, plastic, polymer, ceramic, and rubber.

Example access cover assemblies, or portions or components thereof, described herein can be made from a single piece (as from a mold, injection mold, die cast, or extrusion process). In addition, or in the alternative, example access cover assemblies (including portions or components thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more components and/or portions of an example access cover assembly to become coupled, directly or indirectly, to one or more other components of the access cover assembly and/or to some other component of a luminaire. A coupling feature can include, but is not limited to, a clamp, a portion of a hinge, an aperture, a recessed area, a protrusion, a hole, a slot, a tab, a detent, and mating threads. One portion of an example access cover assembly can be coupled to another component of the access cover assembly and/or to some other component of a luminaire by the direct use of one or more coupling features.

In addition, or in the alternative, a portion of an example access cover assembly can be coupled to another component of the access cover assembly and/or to another component (e.g., an enclosure, a housing) of a luminaire using one or more independent devices that interact with one or more coupling features disposed on a component of the access cover assembly. Examples of such devices can include, but are not limited to, a pin, a hinge, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

In the foregoing figures showing example embodiments of access cover assemblies for luminaires, one or more of the components shown may be omitted, repeated, and/or substituted. Accordingly, example embodiments of access cover assemblies for luminaires should not be considered limited to the specific arrangements of components shown in any of the figures. For example, features shown in one or more figures or described with respect to one embodiment can be applied to another embodiment associated with a different figure or description.

In certain example embodiments, luminaires having example access cover assemblies are subject to meeting certain standards and/or requirements. For example, the National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) set standards as to electrical enclosures, wiring, and electrical connections. Use of example embodiments described herein meet (and/or allow the luminaires to meet) such standards when applicable.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number or a four-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of access cover assemblies for luminaires will be described more fully hereinafter with reference to the accompanying drawings, in which example embodiments of access cover assemblies for luminaires are shown. Access cover assemblies for luminaires may, however, be embodied in many different forms and should not be construed as limited to the example embodiments set forth herein. Rather, these example embodiments are provided so that this disclosure will be thorough and complete, and will fully convey the scope of access cover assemblies for luminaires to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of access cover assemblies for luminaires. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

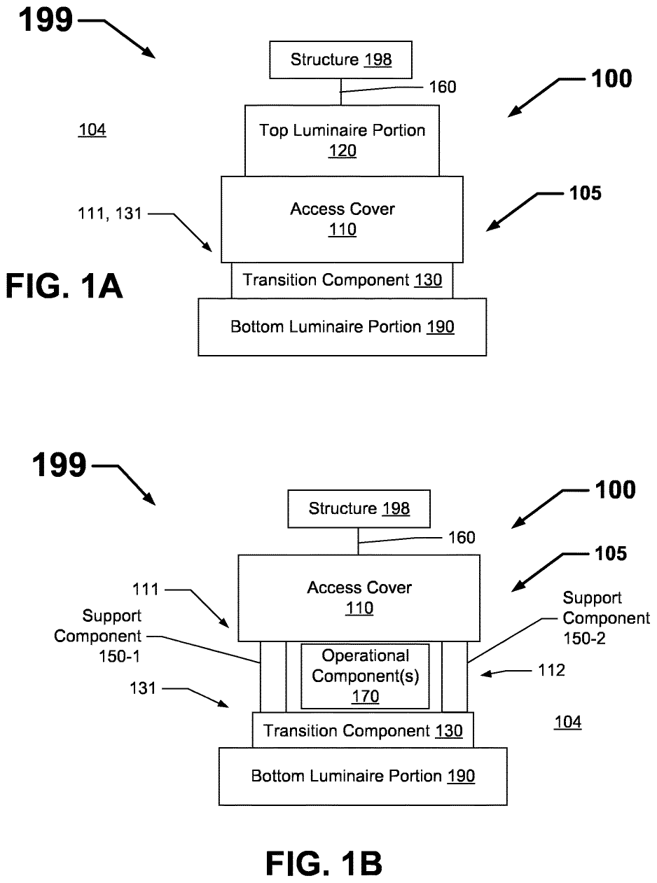

FIGS. 1A and 1B show a system block diagram of a lighting system 199 that includes a luminaire 100 with an access cover assembly 105 according to certain example embodiments. Specifically, FIG. 1A shows a system block diagram of the lighting system 199 that includes the luminaire 100 with the access cover 110 of the access cover assembly 105 in the closed position. FIG. 1B shows a system block diagram of the lighting system 199 that includes the luminaire 100 with the access cover 110 of the access cover assembly 105 in the open position. The lighting system 199 includes a structure 198 and the luminaire 100. The luminaire 100 in this case includes a top luminaire portion 120, the access cover assembly 105, one or more operational components 170, and a bottom luminaire portion 190. The access cover assembly 105 includes the access cover 110, a transition component 130, and one or more support components 150.

The structure 198 can be a physical element from which the luminaire 100 is directly or indirectly supported. Examples of a structure 198 can include, but are not limited to, a ceiling, a truss, an I-beam, a lattice, a rafter, a purlin, a pole, and a building wall. While the structure 198 in this case is shown to be positioned above the luminaire 100, in alternative embodiments the structure 198 can be located at another location (e.g., below, to the side) relative to the luminaire 100.

One or more connecting components 160 are used to connect and support the luminaire 100 relative to the structure 198. A connecting component 160 can be rigid, flexible, solid, hollow, bent, straight, angled, and/or have any other characteristics. In some cases, a connecting component 160 is hollow to allow one or more electrical cables and/or electrical conductors to be disposed therein.

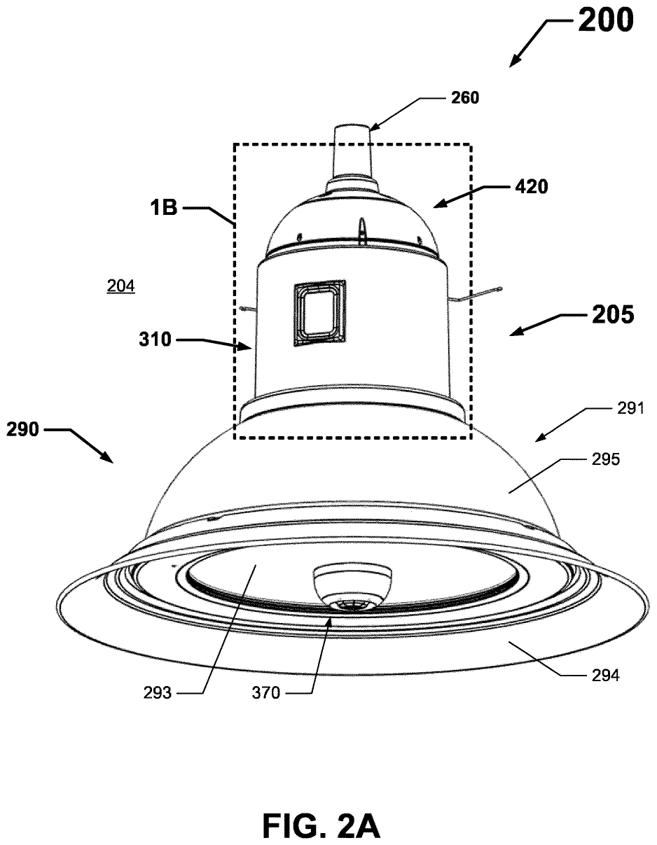

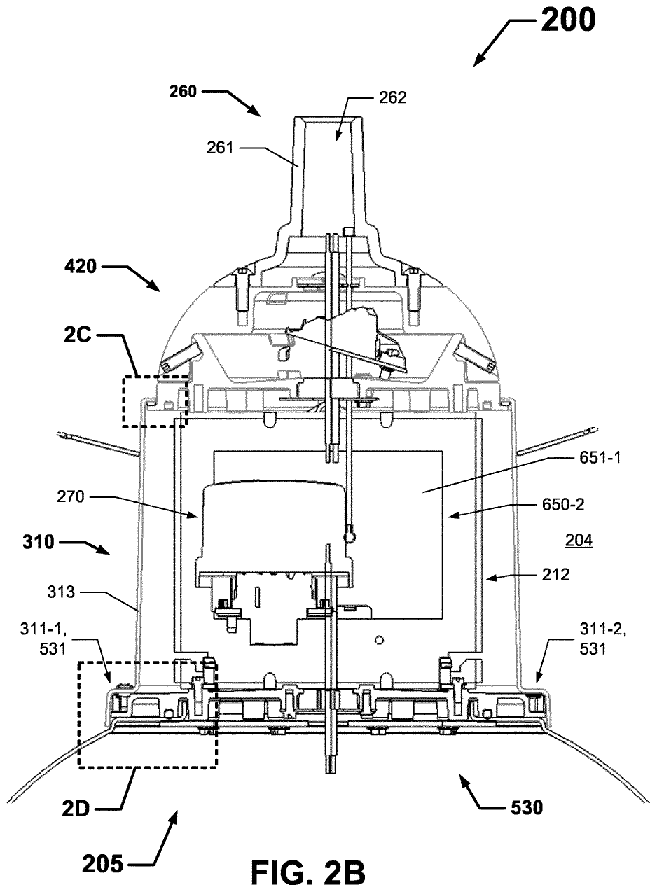

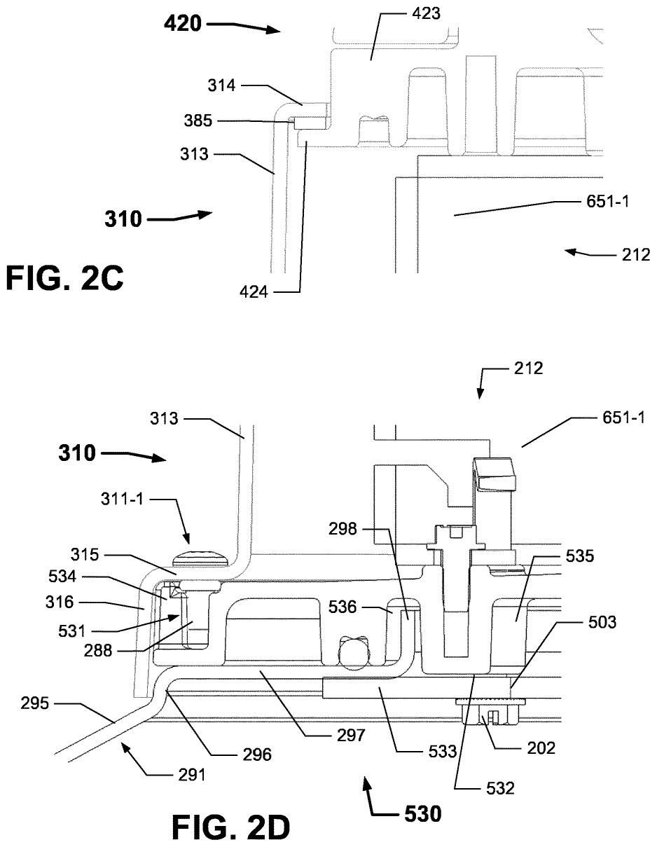

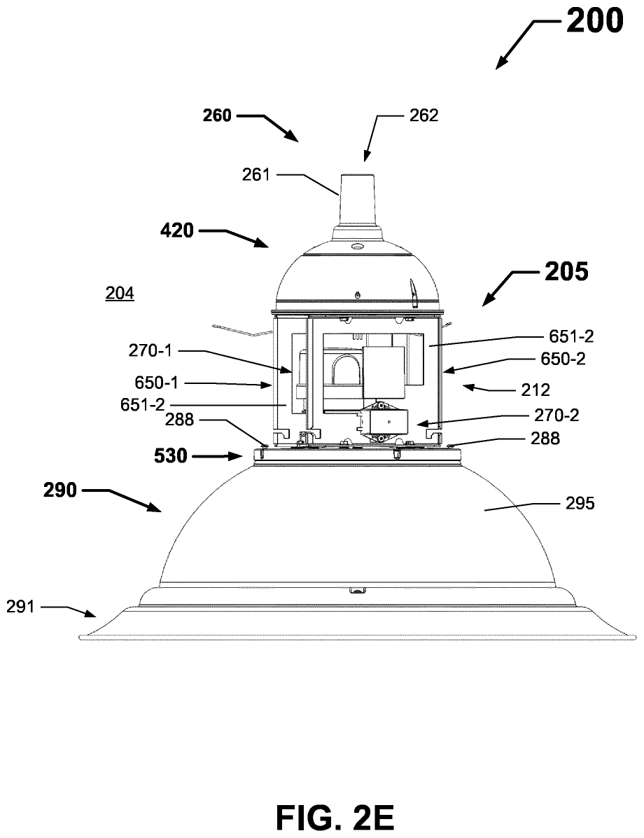

The top luminaire portion 120 of the luminaire 100 is or may include one or more components of the luminaire 100 that are located above the access cover 110 when the access cover 110 is in a closed position, as shown in FIG. 1A. In certain example embodiments, as when the luminaire 100 is a pendant fixture or other type of hanging fixture, the top luminaire portion 120 can be or include a component used to suspend the rest of the luminaire 100 and/or to receive electrical cables and/or electrical wires that terminate with other lower-placed components of the luminaire 100. An example of this is shown in FIGS. 2A through 2E below. In some cases, the top luminaire portion 120 (or portions thereof) includes components of luminaires that exist in the current art with little to no modification.

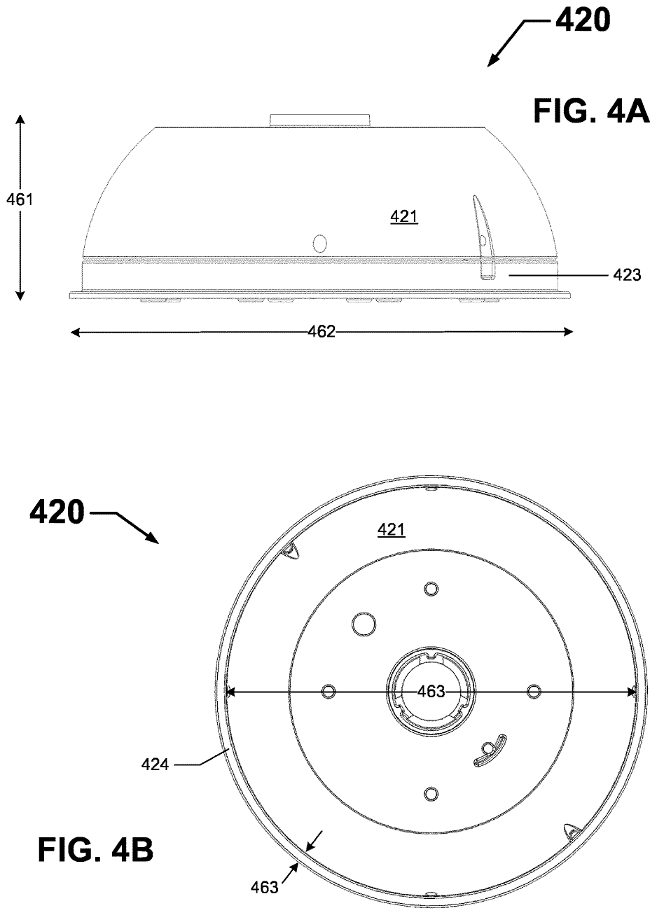

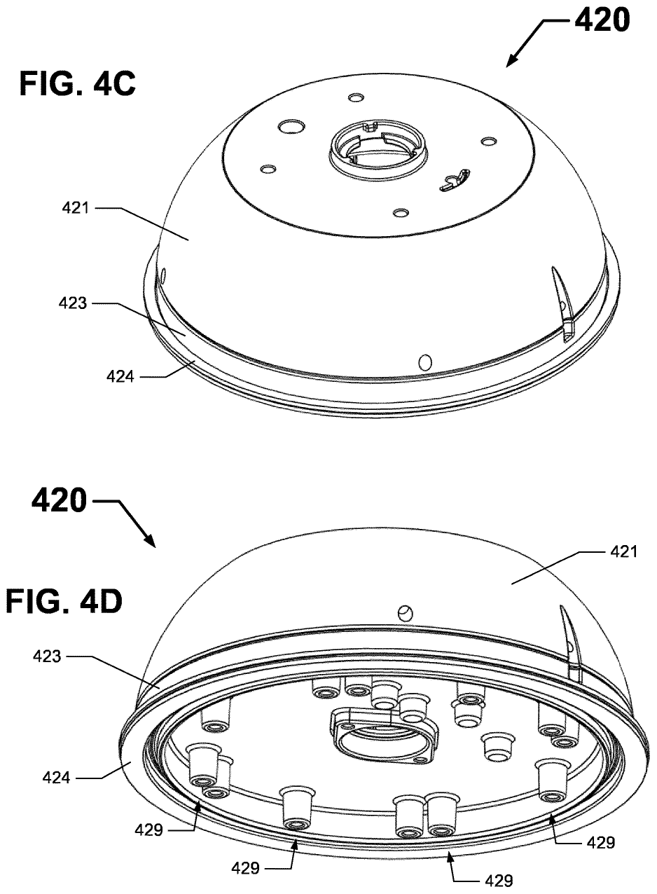

In certain example embodiments, the bottom end of the top luminaire portion 120 is configured to interact with (e.g., abut against) the top collar (discussed below) of the access cover 110 of the access cover assembly 105 when the access cover 110 is in a closed position. In some cases, the interaction between the bottom end of the top luminaire portion 120 is configured to interact with (e.g., abut against) the top collar of the access cover 110 does not involve coupling features. More details about the top luminaire portion 120 are provided below with respect to FIGS. 4A through 4D.

The bottom luminaire portion 190 of the luminaire 100 is or may include one or more components of the luminaire 100 that are located below the access cover 110 when the access cover 110 is in a closed position, as shown in FIG. 1A. In some cases, the bottom luminaire portion 190 can include components such as, but not limited to, a trim, a reflector, a lens, a circuit board, one or more light sources, a controller, and a cover. In some cases, the bottom luminaire portion 190 (or portions thereof) includes components of luminaires that exist in the current art with little to no modification.

In certain example embodiments, the top end of the bottom luminaire portion 190 is configured to interact with (e.g., couple to) the transition component 130 (discussed below) of the access cover assembly 105. In some cases, the top end of the bottom luminaire portion 190 and the transition component 130 remain coupled to each other regardless of whether the access cover 110 is in a closed position or an open position.

Each operational component 170 of the luminaire is located in a space 112 between the transition component 130 and the top luminaire portion 120. An operational component may be accessible to a user when the access cover 110 is in an open position, as shown in FIG. 1B. When the access cover 110 is in a closed position, the space 112 is covered by the access cover 110, and so the operational components 170 are inaccessible, as shown in FIG. 1A.

An operational component 170 is a component that is used in the operation of the luminaire 100 in some capacity. Examples of an operational component 170 may include, but are not limited to, a sensor device (e.g., photocell, an infrared sensor), a surge protector, a power supply (e.g., a driver, a ballast), a controller, and a dimming module. In some cases, an operational component 170 can be potted or otherwise insulated from elements (e.g., dust, moisture) in the ambient environment 104 that enter the space 112. In other cases, some or all of the space 112 is potted or otherwise insulated, and some or all of the operational components 170 may be positioned within the potting or other insulating feature.

Accessing the space 112 is a benefit of example access cover assemblies such as the access cover assembly 105 of FIGS. 1A and 1B. When the access cover 110 of the access cover assembly 105 is in a closed position, as in FIG. 1A, the wall of the access cover 110 encloses the space 112, and the top collar and the bottom of the access cover 110 protects the space 112 from outside elements (e.g., dust, moisture) in the ambient environment 104 by creating a barrier with the bottom luminaire portion 190 and the top luminaire portion 120, respectively. When the access cover 110 or the access cover assembly 105 is in an open position, as in FIG. 1B, the space 112 is accessible.

Each of the support components 150 of the access cover assembly 105 is configured to maintain a constant vertical distance between the top luminaire portion 120 and the transition component 130. In this way, the height of the space 112 remains substantially constant, regardless of whether the access cover 110 is in an open position or a closed position. An access cover assembly 105 can include one support component 150 or multiple (e.g., 2, 4, 8) support components 150. In this case, there are two support components 150 (support component 150-1 and support component 150-2). Each support component 150 can have any of a number of characteristics (e.g., shape, size, thickness, width, material). When an access cover assembly 105 has multiple support components 150, the characteristics of one support component 150 can be substantially the same as, or different than, the corresponding characteristics of one or more of the other support components 150.

The support components 150 are located in the space 112. In this way, when the access cover 110 of the access cover assembly 105 is in a closed position, the support components 150 are not accessible, and when the access cover 110 of the access cover assembly 105 is in an open position, the support components 150 are accessible. If some or all of the space 112 is potted or otherwise insulated, some or all of each support component 150 can be positioned in the potting or other insulating material. An example of a support component 150 can include, but is not limited to, a bracket.

The transition component 130 of the access cover assembly 105 can define the bottom of the access cover assembly 105. The transition component 130 can be configured to be coupled to the top end of the bottom luminaire portion 190, to the access cover 110, and to the bottom end of the support components 150. The transition component 130 can include one or more coupling features 131 (also sometimes referred to as access cover coupling features 131) that are configured to complement the coupling features 111 (also sometimes referred to as transition component coupling features 111) of the access cover 110 so that the access cover 110 and the transition component 130 can be directly or indirectly coupled to each other.

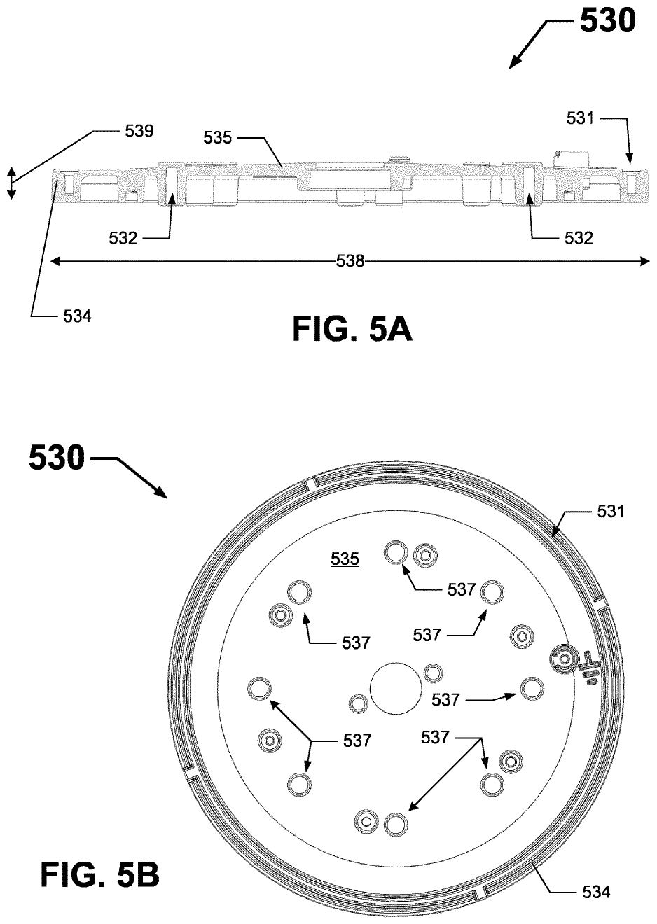

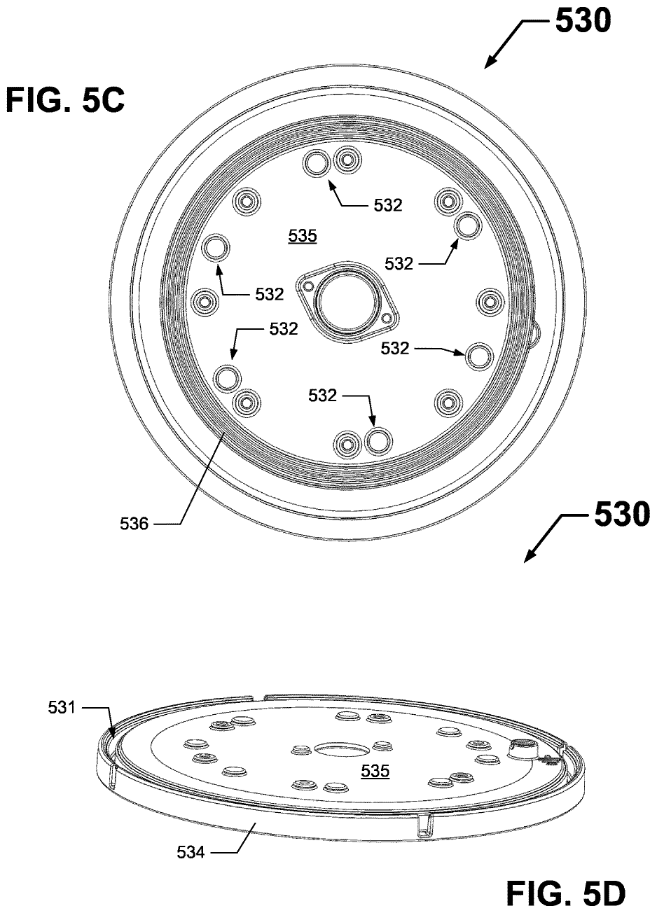

Each coupling feature 131 of the transition component 130 can have any of a number of configurations (e.g., an aperture, a slot, a tab). In any case, the configuration of a coupling feature 131 of the transition component 130 is designed to complement a coupling feature 111 of the access cover 110 so that the access cover 110 and the transition component 130 can be directly or indirectly coupled to each other. More details about the transition component 130 are provided below with respect to FIGS. 5A through 5D.

The access cover 110 of the access cover assembly 105 is movable between an open position and a closed position. As defined herein, an open position of the access cover 110 means that the access cover 110 (which is movable) is located in such a position relative to the rest of the access cover assembly 105 (which remains stationary) that the space 112 between the top luminaire portion 120 and the bottom luminaire portion 190 is completely enclosed and not accessible. Because there are a multiple number of positions that the access cover 110 can have relative to the rest of the access cover assembly 105, the access cover 110 can be considered in a closed position within a range of positions relative to the access cover assembly 105. For example, when the access cover coupling feature 131 of the transition component 130 and the transition component coupling feature 111 of the access cover 110 are coupled to each other, the access cover 110 is in a fully closed position.

Also, as defined herein, a closed position of the access cover 110 means that the access cover 110 is located in such a position relative to the rest of the access cover assembly 105 that the space 112 between the top luminaire portion 120 and the bottom luminaire portion 190 is sufficiently exposed that one or more of the operational components 170 within the space 112 are accessible. Because there are a multiple number of positions that the access cover 110 can have relative to the rest of the access cover assembly 105, the access cover 110 can be considered in an open position within a range of positions relative to the access cover assembly 105. For example, when the access cover 110 is raised to the point of covering some or all of the top luminaire portion 120, as shown in FIG. 1B, the access cover 110 is in a fully open position.

The access cover 110 of the access cover assembly 105 is configured to provide a sufficient seal, when in the closed fully closed position, to protect the space 112 from elements present in the ambient environment 104 in a manner that allows the luminaire 100 to comply with applicable standards for the environment in which the luminaire 100 is placed. When the transition component coupling features 111 and the access cover coupling features 311 are decoupled from each other, the access cover 110 may be movable to allow full or partial access to the space 112.

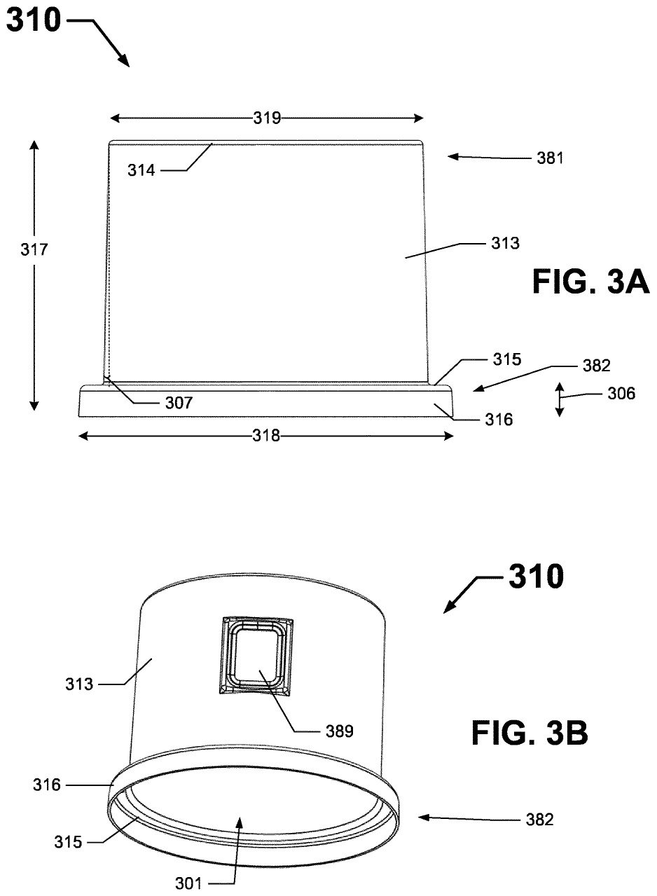

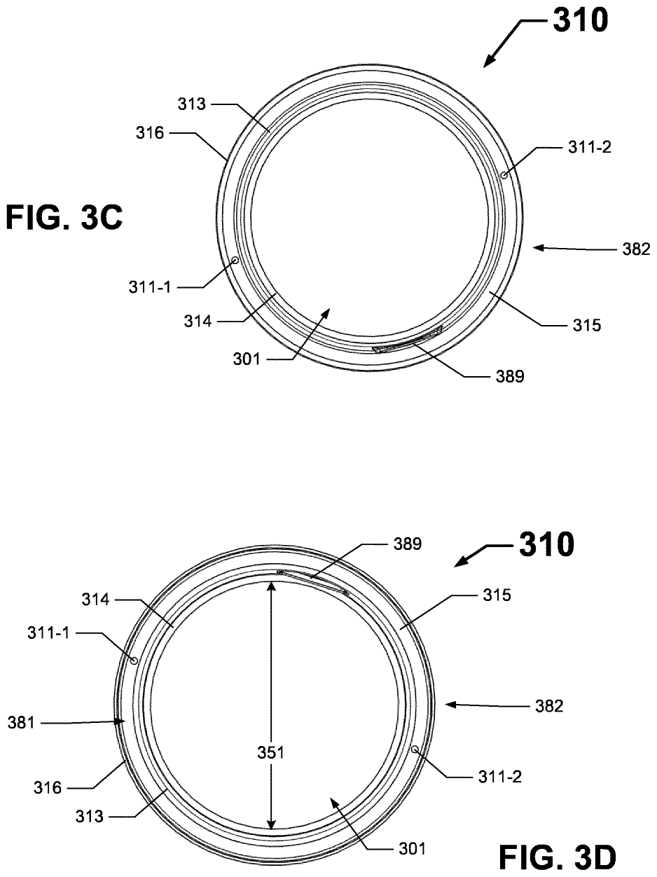

Each coupling feature 111 of the access cover 110 can have any of a number of configurations (e.g., an aperture, a slot, a tab). In any case, the configuration of a coupling feature 111 of the access cover 110 is designed to complement a coupling feature 131 of the transition component 130 so that the access cover 110 and the transition component 130 can be directly or indirectly coupled to each other. More details about the transition component 130 are provided below with respect to FIGS. 3A through 3D.

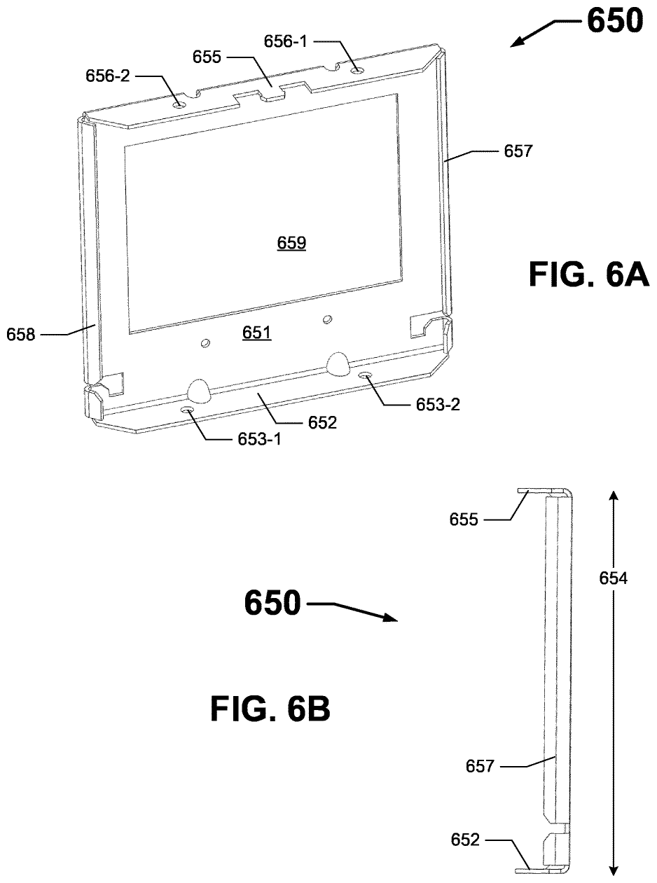

FIGS. 2A through 2E show various views of a luminaire 200 with an access cover assembly 205 according to certain example embodiments. FIGS. 3A through 3D show various views of the access cover 310 of the luminaire 200 of FIGS. 2A through 2E. FIGS. 4A through 4D show various views of the top luminaire portion 420 of the luminaire 200 of FIGS. 2A through 2E. FIGS. 5A through 5D show various views of the transition component 530 of the luminaire 200 of FIGS. 2A through 2E. FIGS. 6A and 6B show various views of a support component 650 of the luminaire 200 of FIGS. 2A through 2E.

Specifically, FIG. 2A shows a front perspective view of the luminaire 200. FIG. 2B shows a cross-sectional front view of part of the luminaire 200. FIG. 2C shows a detailed view of a portion of the cross-sectional front view of the luminaire 200 of FIG. 2B. FIG. 2D shows a detailed view of another portion of the cross-sectional front view of the luminaire 200 of FIG. 2B. FIG. 2E shows a front view of the luminaire 200 without the access cover 310. FIG. 3A shows a side view of the access cover 310. FIG. 3B shows a bottom-side perspective view of the access cover 310. FIG. 3C shows a top view of the access cover 310. FIG. 3D shows a bottom view of the access cover 310.

FIG. 4A shows a side view of the top luminaire portion 420. FIG. 4B shows a top view of the top luminaire portion 420. FIG. 4C shows a top perspective view of the top luminaire portion 420. FIG. 4D shows a bottom perspective view of the top luminaire portion 420. FIG. 5A shows a sectional side view of the transition component 530. FIG. 5B shows a top view of the transition component 530. FIG. 5C shows a bottom view of the transition component 530. FIG. 5D shows a top-side perspective view of the transition component 530. FIG. 6A shows a top-rear-side perspective view of the support component 650. FIG. 6A shows a side view of the support component 650.

Referring to FIGS. 1A through 6B, the luminaire 200 of FIGS. 2A through 6B includes and/or is associated with a top luminaire portion 420, a bottom luminaire portion 290, an access cover assembly 205, an access cover 310, one or more support components 650, a transition component 530, one or more operational components 270, one or more transition component coupling features 311, one or more access cover coupling features 531, a space 212, and an ambient environment 204. These components of and/or associated with the luminaire 200 of FIGS. 2A through 6A can be substantially the same as the top luminaire portion 120, the bottom luminaire portion 190, the access cover assembly 105, the access cover 110, the support components 150, the transition component 130, the operational components 170, the transition component coupling features 111, the access cover coupling features 131, the space 112, and the ambient environment 104 discussed above with respect to the luminaire 100 of FIGS. 1A and 1B.

In this case, the luminaire 200 is a hanging-style (e.g., a pendant) of luminaire that is suspended from a structure (e.g., structure 198) by a connecting component 260 in the form of a conduit, which is coupled to the top end of the top luminaire portion 420. The connecting component 260 can be substantially the same as the connecting component 160 discussed above. For example, the connecting component 260 has a wall 261 that can be rigid or flexible. The wall 261 of the connecting component 260 can form a cavity 262 along its length. In such a case, one or more electrical cables and/or electrical conductors may be disposed within the cavity 262 of the connecting component 260. The ends of these electrical cables and/or electrical conductors can terminate with one or more components (e.g., operational components 270) of the luminaire 200 to provide power, control, communication, data, and/or other types of signals to operate the luminaire 200.

The top luminaire portion 420 of the luminaire 200, as shown in FIGS. 4A through 4D, in this case is substantially semi-spherically shaped with an upper piece 421 and a lower piece 423. The top luminaire portion 420 has an overall height 461 and an overall width 462. The upper piece 421 of the top luminaire portion 420 has an aperture and one or more features configured to receive the connecting component 260. The bottom piece 423 has a flange 424 along its bottom end that extends out a distance 463 from the rest of the bottom piece 423. The distance 463 is the difference between the overall width 462 of the top luminaire portion 420 and the width of the bottom piece 423 without the flange 424. The underside of the bottom piece 423 of the top luminaire portion 420 can include one or more coupling features 429 (also called support component coupling features 429) that are configured to directly or indirectly couple to the coupling features 656 (also called top luminaire portion coupling features 656) of one or more of the support components 650. In this case, the coupling features 429 are in the form of apertures that allow the top luminaire portion 420 to be indirectly coupled (using an independent coupling feature such as a screw) to the one or more of the support components 650.

The bottom luminaire portion 290 of the luminaire 200 in this case includes a lower cover 291, a trim 294, a waveguide 293, and an operational component 370 in the form of a sensor device. The lower cover 291 is configured to be coupled to the transition component 530 of the access cover assembly 205. In this case, the lower cover 291 includes a wall 295. As shown in FIG. 2D, at the top of the wall 295 are one or more of a number of features (in this case, a proximate vertical segment 296, followed by a horizontal segment 297, followed by a distal vertical segment 298) that are configured to complement one or more corresponding coupling features 532 (e.g., apertures, slots), which can also be called plate coupling features 532, in the underside of the transition component 530.

The transition component 530 (including portions thereof) of the access cover assembly 205 of the luminaire 200 can have any of a number of features and/or configurations. An example of one embodiment of the transition component 530 is shown in detail in FIGS. 2A through 2E and 5A through 5D. The transition component 530 in this case includes a body 535 that is substantially cylindrical in shape with a short height 539 relative to the overall width 538. On the underside of the body 535 of the transition component 530 are a number of coupling features 536 (also called bottom luminaire portion coupling features 536) in the form of slots that are configured to receive the distal vertical segments 298 of the lower cover 291. The underside of the body 535 of the transition component 530 also includes the one or more coupling features 532 (in this case, in the form of apertures) that are configured to receive an independent coupling feature 202 (in this case, in the form of a bolt).

The transition component 530 also includes one or more plates 533 in this example. In this case, as shown in FIG. 2D, each plate 533 can be used to secure the horizontal segment 297 of the lower cover 291 in place relative to the transition component 530. Each plate 533 of the transition component 530 can include one or more coupling features 503 (in this case, one or more apertures), which can also be called body coupling features 503, that can be used, in conjunction with a plate coupling feature 532 in the body 535, to directly or indirectly (as in this case using coupling feature 202 in the form of a screw) couple the plate 533 to the body 535 of the transition component 530.

On the top side of the body 535 of the transition component 530 in this example are one or more coupling features 537 (also called support component coupling features 537) that are configured to couple, directly or indirectly, to one or more corresponding coupling features 653 (also called transition component coupling features 653) in the bottom end of one or more of the support components 650. In this case, the coupling features 537 are in the form of apertures, which allows the transition component 530 to be indirectly coupled to each of the one or more support components 650 using an independent coupling feature such as a screw. The coupling of the transition component 530 and the support components 650 can be independent of the position of the access cover 310 relative to the rest of the access cover assembly 205.

On the top side of the body 535 of the transition component 530 in this example are one or more coupling features 531 (also called access cover coupling features 531) that are configured to couple, directly or indirectly, to one or more corresponding coupling features 311 in the bottom collar 382 of the access cover 310. In this case, the coupling features 531 are in the form of one or more slots that track along and just inside the outer wall 534 of the transition component 530, which allows the transition component 530 and the access cover 310 to be indirectly coupled to each other using an independent coupling feature such as a screw. Once the access cover 310 is decoupled from the transition component 530, the position of the access cover 310 can change (e.g., be manually moved by a user) relative to the rest of the access cover assembly 205 while the rest of the access cover assembly 205 remains stationary.

Each support component 650 (including portions thereof) of the access cover assembly 205 of the luminaire 200 can have any of a number of features and/or configurations. An example of one embodiment of a support component 650 is shown in detail in FIGS. 2A through 2E, 6A, and 6B. In this case, there are two support components 650 that are configured substantially identically to each other. The support component 650 in this case includes a body 651 that is substantially planar and has a height 654 that is substantially the same as the height of the space 212. In this example, support component 650-1 includes a body 651-1, and support component 650-2 includes a body 651-2. The support component 650 in this example has a top flange 655 that extends laterally away from the top end of the body 651 and a bottom flange 652 that extends laterally away from the bottom end of the body 651. In this way, the top flange 655 and the bottom flange 652 are substantially parallel to each other.

The top flange 655 of the support component 650 can include one or more coupling features 656 (also called top luminaire portion coupling features 656) that are configured to couple directly or indirectly to the coupling features 429 of the top luminaire portion 420. In this case, the coupling features 656 are in the form of apertures that allow the support component 650 to be indirectly coupled (using an independent coupling feature such as a screw) to the top luminaire portion 420. Similarly, the bottom flange 652 of the support component 650 can include one or more coupling features 653 (also called transition component coupling features 653) that are configured to couple directly or indirectly to the coupling features 537 of the transition component 530. In this case, the coupling features 653 are in the form of apertures that allow the support component 650 to be indirectly coupled (using an independent coupling feature such as a screw) to the transition component 530.

To help stiffen and reinforce the body 651 of a support component 650, the support component 650 can include one or more features to allow the body 651 to support additional weight without significantly warping or otherwise losing its planar configuration. For example, in this case, the left side of the body 651 can have a rolled edge 657, and the right side of the body 651 can have a similar rolled edge 658. Also, to allow for easier access to an operational component 270 within the space 212, the body 651 can have one or more windows 659 or other type of apertures that traverse the thickness of the body 651. In this example, there is only one rectangular window 659 that is substantially centered vertically in the body 651 of the support component 650.

The access cover 310 (including portions thereof) of the access cover assembly 205 of the luminaire 200 can have any of a number of features and/or configurations. An example of one embodiment of the access cover 310 is shown in detail in FIGS. 2A through 3D. The access cover 310 in this case includes a body 313 (in this case, in the form of or including a wall) that is substantially cylindrical in shape with a height 317. In some cases, as in this example, rather than being cylindrical, the body 313 of the access cover 310 can be conical to some degree. In this example, the body 313 flares outward from top to bottom by a very acute angle 307, giving the body 313 of the access cover 310 a slightly conical shape. In any case, the body 313 of the access cover 310 forms a cavity 301 with an open top and an open bottom.

In certain example embodiments, the body 313 of the access cover 310 can include one or more features and/or components to assist with the operation of the luminaire 200. For example, in this case, the wall of the body 313 of the access cover 310 has a window 389 disposed therein. In this case, the window 389 replaces an entire thickness of the wall of the body 313. Such a configuration may occur, for example, when one of the operational components 270 is or includes a sensor device that uses the window 389 to measure a parameter in the ambient environment 204 outside the cavity 301 formed by the wall of the body 313 of the access cover 310 when the access cover 310 is in the fully closed position. As another example, the window 389 can be used to allow a user to make a visual inspection of the space 212 (or a portion thereof) while the access cover 310 is in the fully closed position and before moving the access cover 310 to an open position.

The access cover 310 in this case also includes a top collar 381 located along a top of the body 313. As shown in FIG. 2C, the top collar 381 can be configured to abut against and cover the bottom end (in this case, the flange 424) of the top luminaire portion 420 when the access cover coupling feature 531 of the transition component 530 and the transition component coupling feature 311 of the access cover 310 are coupled to each other. In this case, the top collar 381 is a flange 314 that extends laterally inward from the top of the body 313 by a distance that is the difference between the outer diameter 319 of the top collar 381 and the diameter 351 formed by the inner surface of the flange 314. This distance is substantially the same as, or slightly less than, the distance 463 that the flange 424 extends away from the bottom of the top luminaire portion 420. In this case, the flange 314 of the top collar 381 is separated by a distance 351 that is less than the distance 462 of the flange 424 of the top luminaire portion 420 but greater than the outer diameter of the bottom piece 423 of the top luminaire portion 420.

In certain example embodiments, a sealing member 385 is disposed between the flange 424 of the top luminaire portion 420 and the top collar 381 of the access cover 310. The sealing member 385 can provide a seal between the top luminaire portion 420 and the access cover 310 when the access cover 310 is in the fully closed position (e.g., when the access cover coupling feature 531 of the transition component 530 and the transition component coupling feature 311 of the access cover 310 are coupled to each other). The sealing member 385 can prevent one or more elements (e.g., dust, moisture) from the ambient environment 204 from entering the space 212.

The access cover 310 in this case also includes a bottom collar 382 located along a bottom of the body 313. The bottom collar 382 includes a horizontal wall 315 that extends laterally away from the bottom of the wall of the body 313 of the access cover 310 by a distance. The bottom collar 382 also includes a vertical wall 316 that extends laterally downward from the distal end of the horizontal wall 315 of the bottom collar 382 by a distance 306, which equates to the height 306 of the bottom collar 382. As a result, the bottom collar 382 has an inner diameter 318 that is slightly larger than the overall width 538 of the transition component 530. The height 306 of the bottom collar 382 can be at least as great as the height 539 of the transition component 530, as shown in FIG. 2D. In some cases, as in this example, the height 306 of the bottom collar 382 exceeds the height 539 of the transition component 530 so much that the distal end of the vertical wall 316 of the bottom collar 382 covers the top end of the bottom luminaire portion 290 when the access cover 310 is in the fully closed position (e.g., when the access cover coupling feature 531 and the transition component coupling features 311 are coupled to each other).

As a result, as shown in FIG. 2D, the bottom collar 382 can be configured to abut against and cover the outer portions of the transition component 530 when the access cover 310 is in the fully closed position. To achieve and maintain the fully closed position, the access cover 310 can include one or more transition component coupling features 311. Each transition component coupling feature 311 of the access cover 310 is configured to directly or indirectly couple to an access cover coupling feature 531 of the transition component 530 so that the access cover 310 and the transition component 530 can be coupled to each other.

In this case, there are two transition component coupling features 311 (transition component coupling feature 311-1 and transition component coupling feature 311-2), each in the form of an aperture, that allow the access cover 310 to be indirectly coupled (using an independent coupling feature 288 such as a screw) to the transition component 530. In this case, transition component coupling feature 311-1 and transition component coupling feature 311-2 are located substantially opposite each other on the horizontal wall 315 of the bottom collar 382. In alternative embodiments, there can be one transition component coupling feature 311 or more than two transition component coupling features 311. When there are multiple transition component coupling features 311, they can be space equidistantly from each other or in some other fashion (e.g., randomly).

In this case, there are two operational components 270 located within the space 212. Specifically, operational component 270-1 is or includes a photocell, which uses the window 389 in the body 313 of the access cover 310 to detect an amount of light in the ambient environment 204. Operational component 270-2 is or includes a dimming module to control the amount of light emitted by the light sources of the luminaire 200. Both of these operational components 270 can be accessed by a user when the access cover 310 is moved (e.g., lifted) to an open position (e.g., the fully open position).

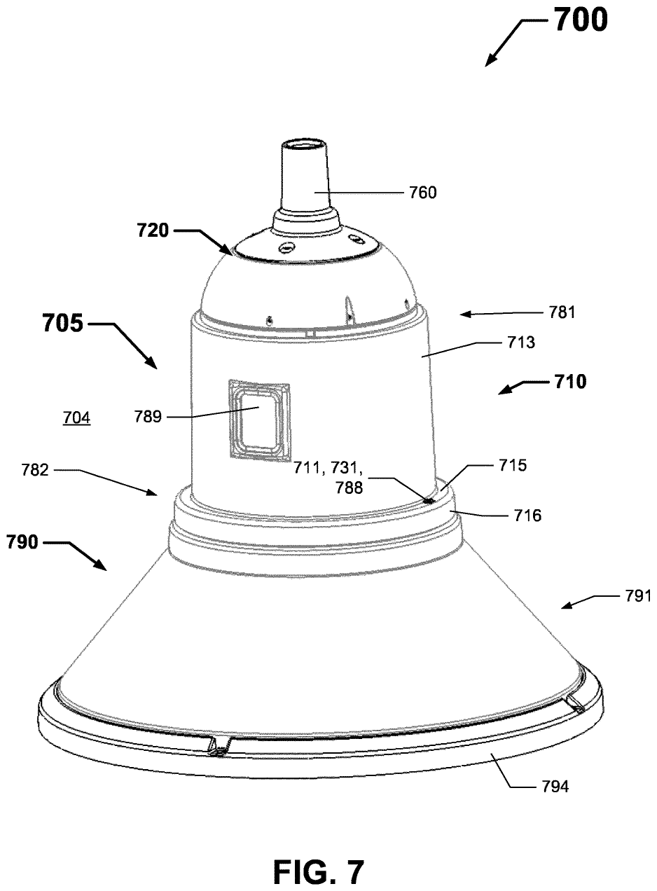

FIG. 7 shows another luminaire 700 with the access cover 710 in a closed position according to certain example embodiments. Referring to FIGS. 1A through 7, the luminaire 700 of FIG. 7 includes and/or is associated with a connecting component 760, a top luminaire portion 720, a bottom luminaire portion 790, an access cover assembly 705, an access cover 710 (which includes a window 789 in the body 713, a bottom collar 782 (including a horizontal wall 715 and a vertical wall 716), and a top collar 781), one or more support components (hidden from view), a transition component (hidden from view), one or more operational components (hidden from view), one or more transition component coupling features 711, one or more access cover coupling features 731, one or more coupling features 788, a space (hidden from view), and an ambient environment 704. These components of and/or associated with the luminaire 700 of FIG. 7 can be substantially the same as the corresponding components discussed above with respect to FIGS. 1A through 6B, except as described below.

For example, in this case, the lower cover 791 of the bottom luminaire portion 790 of the luminaire 700 of FIG. 7 is more conically shaped rather than the semi-spherical shape of the lower cover 295 of the bottom luminaire portion 290 of the luminaire 200 of FIGS. 2A and 2E. As another example, the trim 7941 of the bottom luminaire portion 790 of the luminaire 700 of FIG. 7 is shorter and less wide compared to the trim 291 of the bottom luminaire portion 290 of the luminaire 200 of FIGS. 2A and 2E. However, the functionality and other aspects of the access cover assembly 705 of the luminaire 700 of FIG. 7 is substantially the same as the functionality and other aspects of the access cover assemblies discussed above.

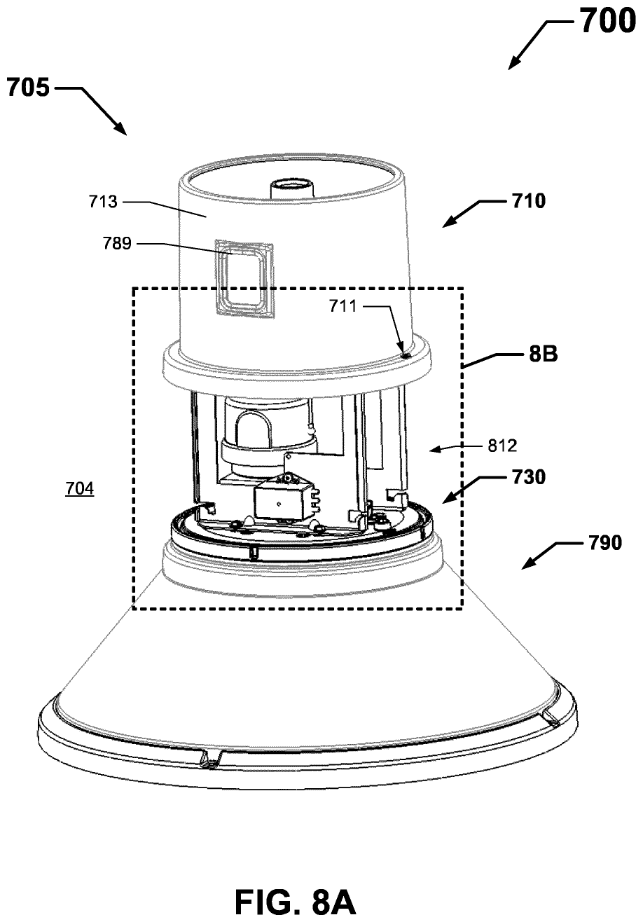

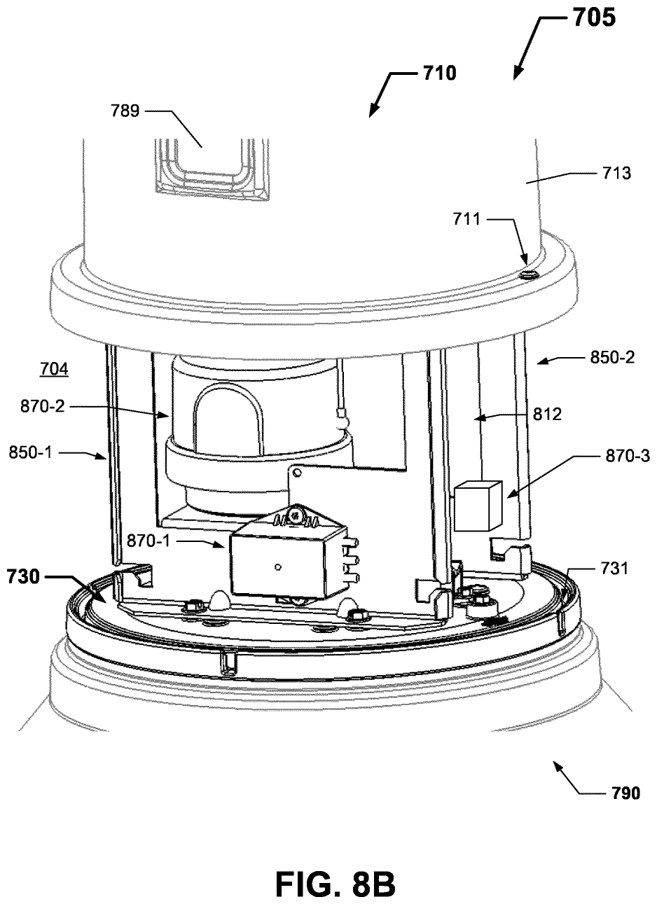

FIGS. 8A and 8B show the luminaire 700 of FIG. 7 with the access cover 710 in an open position, in this case the fully open position. Specifically, FIG. 8A shows a top-front perspective view of the luminaire 700 with the access cover 710 in the fully open position. FIG. 8B shows a detailed view of the access cover assembly 705 and the accessible space 812 shown in FIG. 8A. Referring to FIGS. 1A through 8B, to get the access cover 710 to the fully open position, the independent coupling feature 788 (e.g., a screw) is removed, and then the access cover 710, now decoupled from the transition component 730, is raised upward. With the access cover 710 in the fully open position, the space 812 between the transition component 730 of the access cover assembly 705 and the top luminaire portion 720 (now hidden from view in FIGS. 8A and 8B by the access cover 710) is now accessible.

Positioned within the space 812 are two support components 850 (support component 850-1 and support component 850-2) that are coupled to the top luminaire portion 720 at their top end and to the transition component 730 at their bottom end. The support components 850 are disposed within the cavity (e.g., cavity 301) formed by the body 713 of the access cover 710 when the access cover 710 is in the fully closed position (as shown in FIG. 7), which corresponds to when the access cover coupling feature 731 and the transition component coupling feature 711 are indirectly coupled to each other.

Now that the access cover coupling feature 731 and the transition component coupling feature 711 are decoupled from each other and the access cover 710 is moved upward toward the top luminaire portion and away from the transition component to the fully open position, as shown in FIGS. 8A and 8B, the support components 850 are exposed to the ambient environment 704. Also, the bottom luminaire portion coupling feature of the transition component 730 remains coupled to the transition component coupling feature of the bottom luminaire portion 790 when the access cover 710 is in an open position.

Also positioned within the space 812 and accessible when the access cover 710 is moved to the fully open position are three operational components 870. Operational component 870-1 is a surge protector, operational component 870-2 is a sensor device in the form of a photocell, and operational component 870-3 is a dimming device. The photocell sensor of the operational component 870-2 requires a line of sight to the ambient environment 704, and so the window 789 in the body 713 of the access cover 710 can be used to provide the line of sight by properly orienting the access cover 710 when the access cover 710 is put in the fully closed position.

To accomplish this proper orientation of the window 789 in the access cover 710, the access cover coupling feature 731 and the transition component coupling feature 711 can be positioned on the transition component 730 and the access cover 710, respectively, in such a way that the window 789 is in the required position relative to the operational component 870-2 when the access cover 710 and the transition component 730 are coupled to each other. In addition, or in the alternative, other methods (e.g., using a key (e.g., protrusions, recesses)) can be used with respect to the access cover 710 and/or the transition component 730 in order to properly orient the window 789.

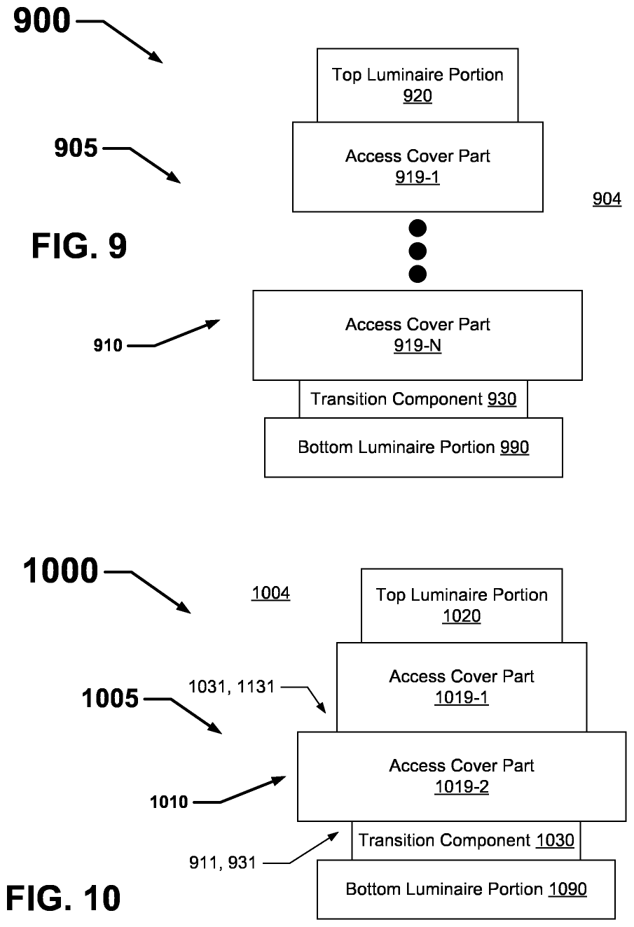

FIG. 9 shows a system block diagram of a luminaire 900 with another access cover assembly 905 according to certain example embodiments. Referring to FIGS. 1A through 9, the luminaire 900 of FIG. 9 is located in an ambient environment 904 and includes a top luminaire portion 920, the access cover 910, a transition component 930, and a bottom luminaire portion 990. These elements of FIG. 9 are substantially similar to the corresponding elements discussed above with respect to FIGS. 1A through 8B, except as discussed below.

In some embodiments, as in this case, the access cover 910 of the access cover assembly 905 can have multiple parts 919 that are independently movable between a closed position and an open position relative to each other. In this example, the access cover 910 has N access cover parts 919 (access cover part 919-1 through access cover part 919-N). Each access cover part 919 of FIG. 9 encases different spaces (similar to the spaces (e.g., space 812) discussed above). A specific example of an access cover having multiple access cover parts is shown in FIGS. 10 through 12.

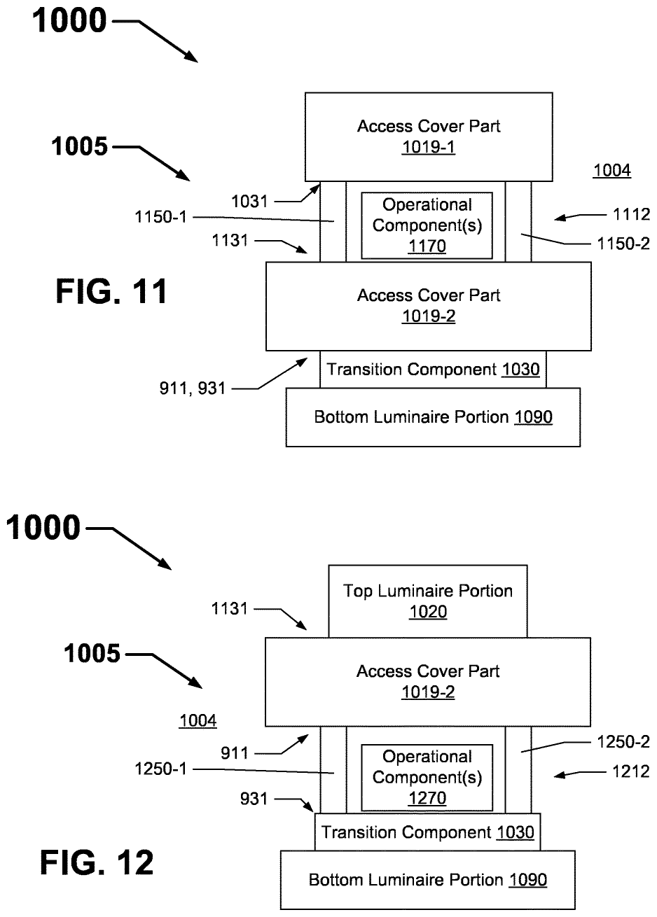

FIG. 10 shows a system block diagram of a luminaire 1000 with yet another access cover assembly 1005 according to certain example embodiments. FIG. 11 shows a system block diagram of the luminaire 1000 of FIG. 10 with one part of the access cover 1010 in a changed position relative to what is shown in FIG. 10. FIG. 12 shows a system block diagram of the luminaire 1000 of FIG. 10 with another part of the access cover 1010 in a changed position relative to what is shown in FIGS. 10 and 11. The luminaire 1000 of FIGS. 10 through 12 is an example of a multi-part access cover 1010. Specifically, the access cover 1010 has two access cover parts 1019. The various elements of FIGS. 10 through 12 are substantially similar to the corresponding elements discussed above with respect to FIGS. 1A through 9, except as discussed below.

Referring to FIGS. 1A through 12, the luminaire 1000 of FIG. 10 is located in an ambient environment 1004 and includes a top luminaire portion 1020, the multi-part access cover 1010 having access cover part 1019-1 and access cover part 1019-2, a transition component 1030, and a bottom luminaire portion 1090. In certain example embodiments, each access cover part 1019 of the access cover 1010 can include one or more of a number of features (e.g., collars, flanges, coupling features) that allow one access cover part 1019 (e.g., access cover part 1019-1) to remain coupled to another access cover part 1019 (e.g., access cover part 1019-2) so that the upper-most access cover part 1019 remains in a fully closed position relative to the lower access cover part 1019.

For example, in this case, the access cover coupling feature 1031 of access cover part 1019-1 and the access cover coupling feature 1131 of access cover part 1019-2 can be configured to directly or indirectly couple to each other. As a result, when access cover coupling feature 1031 and access cover coupling feature 1131 are directly or indirectly coupled to each other, the access cover part 1019-1 is coupled to (is in the fully closed position relative to) the access cover part 1019-2. Similarly, the transition component coupling feature 911 of access cover part 1019-2 and the access cover coupling feature 931 of the transition component 1030 can be configured to directly or indirectly couple to each other. As a result, when transition component coupling feature 911 and access cover coupling feature 931 are directly or indirectly coupled to each other, the access cover part 1019-2 of the access cover 1010 is coupled to (is in the fully closed position relative to) the transition component 1030.

The access cover coupling feature 931, the access cover coupling feature 1031, and the access cover coupling feature 1131 can be substantially similar to the access cover coupling features discussed above. Similarly, the transition component coupling feature 911 can be substantially similar to the transition component coupling features discussed above. FIG. 10 shows the access cover part 1019-1 in the fully closed position relative to the access cover part 1019-2, and the access cover part 1019-2 is shown in the fully closed position relative to the transition component 1030.

In FIG. 11, the access cover coupling feature 1031 of access cover part 1019-1 and the access cover coupling feature 1131 of access cover part 1019-2 are decoupled from each other while the transition component coupling feature 911 of access cover part 1019-2 and the access cover coupling feature 931 of the transition component 1030 remain coupled to each other. As a result, the access cover part 1019-1 of the access cover 1010 is movable relative to the access cover part 1019-2 of the access cover 1010, while the access cover part 1019-2 remains in the fully closed position relative to the transition component 1030.

As shown in FIG. 11, the access cover part 1019-1 is raised until the access cover part 1019-1 envelopes the top luminaire portion 1020 (hidden from view in FIG. 11), thereby making the space 1112 formerly enveloped by the access cover part 1019-1 (as in FIG. 10) accessible. Since the space 1112 is no longer housed within the access cover part 1019-1, the one or more operational components 1170 and the one or more structural components 1150 (in this case, structural component 1150-1 and structural component 1150-2) are accessible in the space 1112.

In FIG. 12, the transition component coupling feature 911 of access cover part 1019-2 and the access cover coupling feature 931 of the transition component 1030 are decoupled from each other. Also, the access cover coupling feature 1031 of access cover part 1019-1 and the access cover coupling feature 1131 of access cover part 1019-2 are decoupled from each other. As a result, the access cover part 1019-2 of the access cover 1010 is movable relative to the transition component 1030 and the access cover part 1019-1. As shown in FIG. 12, the access cover part 1019-2 is raised until the access cover part 1019-2 envelopes the access cover part 1019-1 (hidden from view in FIG. 12), thereby making the space 1212 formerly enveloped by the access cover part 1019-2 (as in FIGS. 10 and 11) accessible. Since the space 1212 is no longer housed within the access cover part 1019-2, the one or more operational components 1270 and the one or more structural components 1250 (in this case, structural component 1250-1 and structural component 1250-2) are accessible in the space 1212.

As an alternative to what is shown in FIG. 12, since the access cover part 1019-1 is also movable, the space 1112 can be accessible at the same time that space 1212 is accessible by raising both access cover part 1019-1 and access cover part 1019-2 higher to envelop the top luminaire portion 1020. As yet another alternative to what is shown in FIG. 12, the access cover coupling feature 1031 of access cover part 1019-1 and the access cover coupling feature 1131 of access cover part 1019-2 can be coupled to each other. In such a case, when the access cover part 1019-2 is raised to expose space 1212 and cover space 1112, the access cover part 1019-1 is simultaneously raised to cover the top luminaire portion 1020. If the tandem of the access cover part 1019-1 and the access cover part 1019-2 continue to be raised upward, then space 1112 can become accessible while space 1212 remains accessible.

Example embodiments can be used to make one or more components (e.g., operational components, support components) accessible without having to uninstall and disassemble the entire luminaire. Example embodiments can be used with luminaires that hang (e.g., pendant fixtures) or are otherwise supported from a structure. Example embodiments can be used with luminaires having any of a number of sizes and/or features. Example embodiments can be used in new installations of luminaires as well as retrofitting existing luminaires. Example embodiments also provide a number of other benefits. Such other benefits can include, but are not limited to, increased ease of maintenance, greater ease of use, catering to user preferences, modularity, ease of installation, and compliance with industry standards that apply to certain luminaires with which example embodiments can be used.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A luminaire comprising:
a top luminaire portion;
a bottom luminaire portion;
an access cover assembly, wherein the access cover assembly comprises:
a transition component comprising an access cover coupling feature and a bottom luminaire portion coupling feature,
an access cover, wherein the access cover includes
a body comprising a wall, wherein the wall forms a cavity with an open top and an open bottom,
a transition component coupling feature configured to couple to the access cover coupling feature of the transition component, and
a support component disposed within the cavity formed by the wall of the body when the access cover is in a closed position, and wherein the support component is configured to be exposed when the access cover is moved to an open position; and
an operational component accessible to a user when the access cover coupling feature and the transition component coupling feature are decoupled from each other and when the access cover is moved toward the top luminaire portion, wherein the wall of the body of the access cover has a window disposed therein, and wherein the operational component uses the window to measure a parameter in an ambient environment outside the cavity formed by the body of the access cover when the access cover is in the closed position;
wherein the body of the access cover has a first inner diameter that is larger than a first outer diameter of the top luminaire portion, and the bottom collar located along a bottom of the body has a second inner diameter that is larger than a second outer diameter of the top end of the bottom luminaire portion.

2. The luminaire of claim 1, wherein the bottom luminaire portion comprises an additional cover.

3. The luminaire of claim 1, wherein the top luminaire portion is configured to be suspended from a structure.

4. The luminaire of claim 1, wherein the operational component comprises at least one of a group consisting of a photocell, a surge protector, a driver, and a dimming module.

5. The luminaire of claim 1, wherein the bottom luminaire portion coupling feature of the transition component remains coupled to the bottom luminaire portion when the access cover is in the open position.

6. The luminaire of claim 1, wherein the body of the access cover has a slightly conical shape.

7. The luminaire of claim 1, wherein a top collar located along a top of the body has a third inner diameter that is smaller than a third outer diameter of the bottom end of the top luminaire portion.

8. The luminaire of claim 1, wherein the access cover comprises multiple parts that are movable relative to each other.
